(19) United States
(12) Patent Application Publication
(10) Pub. No.: US 2026/0147140 A1
(43) Pub. Date: May 28, 2026

(54) PANE COATED WITH ELECTRICALLY CONDUCTIVE LAYER STACK

(71) Applicant: SAINT-GOBAIN GLASS FRANCE, COURBEVOIE (FR)

(72) Inventors: Anna NEFT, HERZOGENRATH (DE); Julie RUFF, HERZOGENRATH (DE); Jan HAGEN, HERZOGENRATH (DE)

(21) Appl. No.: 19/121,582

(22) PCT Filed: Sep. 25, 2023
(86) PCT No.: PCT/EP2023/076372

§ 371 Date: Apr. 16, 2025

(30) Foreign Application Priority Data
Oct. 20, 2022 (EP) 22202709.6

(51) Int. Cl. G02B 1/11

(52) U.S. Cl. CPC G02B 1/11

(57) ABSTRACT

A coated pane includes a substrate and an electrically conductive layer stack on a surface of the substrate, which, starting from the substrate, includes a dielectric barrier layer preventing ion diffusion with a refractive index of at least 1.9 and a layer thickness of 5 nm to 18 nm, a dielectric anti-reflective layer with a refractive index of at most 1.6, an electrically conductive layer with a layer thickness of 75 nm to 120 nm, a dielectric blocking layer for controlling oxygen diffusion with a refractive index of at least 1.9 and a layer thickness of 10 to 25 nm, and a dielectric optical layer with a refractive index of at most 1.6.

The invention relates to a coated pane comprising an electrically conductive layer stack, to a composite pane comprising the coated pane, as well as to the production of the coated pane and its use.

Glass panes having transparent electrically conductive coatings are known. The glass panes can thus be given a function without significantly disrupting the view through the pane. Such coatings are used, for example, as heated coatings or heat radiation-reflecting coatings on window panes for vehicles or buildings.

The interior of a vehicle or a building can heat up strongly in summer at high ambient temperatures and under intense direct solar radiation. If, on the other hand, the outside temperature is lower than the temperature in the interior, which occurs in particular in winter, a cold pane acts as a heat sink which is perceived as unpleasant. The interior must also be heated strongly in order to prevent cooling via the window panes.

Coatings that reflect heat radiation (so-called low-E coatings) reflect a significant portion of solar radiation, particularly in the infrared range, reducing the extent to which the interior heats up in summer. The coating also reduces the emission of long-wave heat radiation from a heated pane into the interior. In winter, when the outside temperature is low, said coating prevents the heat in the interior from radiating to the outside environment.

For optimal function, the heat radiation-reflecting coating must be arranged on the interior-side surface of the pane, i.e. between the interior and the actual glass pane as it were. There, the coating is exposed to the atmosphere, which excludes the use of corrosion-prone coatings, for example those based on silver. Coatings based on transparent conductive oxides (TCO), such as indium tin oxide (ITO) have proven themselves as electrically conductive coatings on exposed surfaces on account of their resistance to corrosion and good degree of conductivity. Such coatings are known, for example, from EP 2 141 135 A1, WO 2010115558 A1 and WO 2011105991 A1. WO2018206236A1 discloses a composite pane having an electrically conductive layer with reflective properties in terms of thermal radiation, wherein fingerprints on the electrically conductive layer are less visible as a result of a special layer structure.

WO2013132176A2 discloses a glazing unit for the building sector having an electrically conductive layer based on ITO, wherein the coating serves in particular to reduce the condensation of moisture on the glazing unit.

WO2015055944A1 describes a process for applying coatings comprising transparent oxides to a substrate.

WO2019106264A1 describes a substrate coated with a low-E layer in conjunction with a bismuth-based cover print, wherein the cover print has good adhesion to the low-E layer.

In addition to thermal criteria, panes with a low-E coating should also meet various other requirements. One problem with coating panes is compatibility with other coatings, especially screen prints. In panes in the automotive sector, a screen print is usually applied to the pane. If the entire pane surface is pre-coated with a low-E coating, problems may arise with the adhesion of the screen print to the pane. This can also lead to reduced scratch resistance of the black print. The low-E coating should also be stable, i.e. chemically inert, at high temperatures. High temperatures are used, for example, when bending panes.

Another common problem that occurs with low-E coatings in conjunction with panes, especially tinted panes, is increased light reflection and colouring of the pane caused by the coating that is dependent on the viewing angle. A high level of reflection and coloration of the pane can have a distracting or aesthetically disturbing effect on the viewer, which can also pose a safety risk, especially when the pane is used as a vehicle window. In the case of panes of the type in question, colour neutrality and light reflection are mutually related. This means that the coated pane has a lower degree of light reflection but stronger coloration, and vice versa.

The object addressed by the present invention is that of providing a coated pane with a heat radiation-insulating effect, which additionally has higher colour neutrality and lower light reflection, in particular at greater angles of incidence.

According to the invention, the object of the present invention is achieved by a coated pane according to claim 1. Preferred embodiments result from the dependent claims.

The pane according to the invention comprises a substrate and an electrically conductive layer stack on a surface of the substrate. Starting from the substrate, the layer stack comprises the following sequence:
a dielectric barrier layer preventing ion diffusion with a refractive index of at least 1.9 and a layer thickness of 5 nm to 18 nm,
a dielectric anti-reflective layer with a refractive index of at most 1.6,
an electrically conductive layer with a layer thickness of 75 to 120 nm,
a dielectric blocking layer for controlling oxygen diffusion with a refractive index of at least 1.9 and a layer thickness of 10 to 25 nm, and
a dielectric optical layer with a refractive index of at most 1.6.

The invention is based on the knowledge that layers with emissivity-reducing properties generally have high reflection properties in the visible light spectrum and/or high chromaticity. However, high reflection and/or chromaticity can be perceived by users as irritating and disturbing. It can also pose a safety risk if, for example, light is reflected too strongly on a pane in a car or traffic signs outside the car are perceived incorrectly (for example, a red sign looks a greenish-reddish colour when viewed through a pane). The tint of the pane depends on the viewing angle. In particular, flat viewing angles on the pane of 60° to 85° to the surface of the pane lead to strong coloration when it is looked through or reflecting something. These flat viewing angles are particularly common in vehicle windshields (flat installation angle) and roof windows (flat viewing angle for passengers sitting in the rear). The inventors found that the dominant colour component, which is largely responsible for the visually strongly perceptible coloration in these types of coated panes, is due to high positive a* values of the LAB colour space. High positive a* values result in a visually perceptible red tint of the pane.

The electrically conductive layer stack according to the invention is a thermal radiation-reflecting coating. Such a layer stack is often also referred to as a low-E coating, low-emissivity coating or emissivity-reducing coating. The function thereof is to prevent heat from entering the interior (IR components of solar radiation and, in particular, thermal radiation from the pane itself) and also to prevent heat from being emitted out of the interior. However, in principle, the layer stack can also fulfil other functions, for example as a heatable coating if it is electrically contacted such that it is heated as a result of an electric current flow.

The pane according to the invention is preferably a window pane and provided for separating the interior from the external environment in an opening of a vehicle or building, for example. The surface of the substrate on which the layer stack according to the invention is arranged is preferably the interior-side surface of the pane or the substrate. Within the context of the invention, the interior-side surface is understood to mean the surface which is intended to face the interior when the pane is installed. This is particularly advantageous with regard to thermal comfort in the interior. Under high outside temperatures and solar radiation, the layer stack according to the invention can particularly effectively at least partially reflect the heat radiation emitted by the entire pane toward the interior. At low outside temperatures, the layer stack can effectively reflect the heat radiation emitted from the interior, thus reducing the effect of the cold pane as a heat sink. Usually, the glazing surfaces are numbered consecutively from the outside in so that in single glazings the interior-side surface is referred to as “side 2”, and in double glazings (for example laminated glass or insulating glazings) as “side 4”. Alternatively, the layer stack can also be arranged on the outer surface of the substrate. This can be particularly useful in the architectural field, for example as an anti-condensation coating on a window pane.

However, the layer stack can also alternatively fulfil other functions, for example as an electrically based capacitive or resistive sensor for tactile applications such as touchscreens or touch panels.

The layer stack is a sequence of thin layers (layer structure, layer stack). While electrical conductivity is ensured by the at least one electrically conductive layer, the optical properties, in particular the transmittance and reflexivity, are largely influenced by the remaining layers and can be specifically adjusted by their design. In this context, so-called anti-reflective layers and optical layers that have a lower refractive index than the electrically conductive layer and are arranged below and above said layer, have a particular influence. These anti-reflective layers which interact with optical layers can, in particular as a result of interference effects, increase transmittance through the pane and reduce reflexivity. The effect depends decisively on the refractive index and layer thickness. In an advantageous embodiment, the layer stack comprises respectively at least one anti-reflective layer below, and at least one optical layer above, the electrically conductive layer. The anti-reflective layer and the optical layer each have a lower refractive index than the electrically conductive layer (refractive index of no more than 1.6, in particular at most 1.5).

The layer stack according to the invention is transparent and therefore does not noticeably restrict visibility through the substrate. The degree of absorption of the layer stack is preferably from about 1% to about 20% in the visible spectral range. The visible spectral range is understood to mean the spectral range of 380 nm to 780 nm.

If a first layer is arranged above a second layer, within the meaning of the invention this means that the first layer is arranged further away from the substrate than the second layer. If a first layer is arranged below a second layer, within the meaning of the invention this means that the second layer is arranged further away from the substrate than the first layer. If a first layer is arranged above or below a second layer, within the meaning of the invention this does not necessarily mean that the first and the second layer are in direct contact with one another. One or more additional layers can be arranged between the first and the second layer, provided that this is not explicitly ruled out.

The layer stack is typically applied over the entire surface of the substrate, possibly with the exception of a peripheral edge region and/or other locally limited regions that can be used, for example, for transmitting data. The coated portion of the substrate surface is preferably at least 80%, in particular at least 90%.

If a layer or another element contains at least one material, within the meaning of the invention this includes the case where the layer consists of the material, which is in principle also preferred. The compounds described within the scope of the present invention, in particular oxides, nitrides and carbides, can in principle be stoichiometric, substoichiometric or superstoichiometric, even if the stoichiometric molecular formulae are mentioned for better understanding.

The electrically conductive layer preferably has a refractive index of 1.7 to 2.3. In an advantageous embodiment, the electrically conductive layer contains at least one transparent electrically conductive oxide (TCO). Such layers are corrosion-resistant and may be used on exposed surfaces. The electrically conductive layer preferably contains indium tin oxide (ITO), which has proven particularly suitable, particularly due to low resistivity and low scattering in terms of sheet resistance. However, the conductive layer can also contain, for example, aluminium-zinc mixed oxide (AZO), indium-zinc mixed oxide (IZO), gallium-doped tin oxide (GZO), fluorine-doped tin oxide (SnO₂:F) or antimony-doped tin oxide (SnO₂:Sb).

The thickness of the electrically conductive layer is from 75 nm to 120 nm, particularly preferably from 75 nm to 100 nm, particularly preferably from 20) 80 nm to 95 nm. This achieves particularly good results in terms of electrical conductivity while maintaining sufficient optical transparency. In this layer thickness range, sufficient emissivity-reducing properties are also achieved without a very strong coloured tint on the pane being produced simultaneously.

In an advantageous embodiment, the layer thickness of the dielectric anti-reflective layer is preferably from 5 nm to 50 nm, preferably from 5 nm to 30 nm, particularly preferably from 5 nm to 20 nm, very particularly preferably from 10 nm to 15 nm. In this layer thickness range, particularly low coloration of the pane is achieved. More particularly, the coloration is very low in a layer thickness range of 5 nm to 20 nm, preferably 10 nm to 15 nm. This finding was unexpected and surprising to the inventors.

If thin layers are mentioned, that is to say layers with a thickness of below 1000 nm, the following applies: if something is formed “on the basis” of a material, it consists predominantly of this material, in particular substantially from this material in addition to any impurities or doping. Unless otherwise indicated, the specification of layer thicknesses or thicknesses refers to the geometric thickness of a layer. If something is formed “on the basis” of a polymeric material, it consists predominantly, that is to say at least 50%, preferably at least 60%, and in particular at least 70%, of this material. It can thus also contain further materials such as, for example, stabilisers or plasticisers.

In an advantageous embodiment, the layer thickness of the dielectric optical layer is preferably from 30 nm to 120 nm, preferably from 50 to 100 nm, particularly preferably from 55 nm to 75 nm, in particular from 60 nm to 70 nm. More particularly, the coloration is very low in a layer thickness range of 55 nm to 75 nm, preferably 60 nm to 70 nm. This finding was unexpected and surprising to the inventors.

In a particularly advantageous embodiment, the layer stack has further anti-reflective layers and/or optical layers.

Anti-reflective layers and optical layers in particular provide advantageous optical properties of the pane. For example, they reduce the reflectance and thereby increase the transparency of the pane and ensure a neutral colour impression. The anti-reflective coatings preferably contain an oxide or fluoride, particularly preferably silicon oxide, aluminium oxide, magnesium fluoride or calcium fluoride. The silicon oxide can have dopants and is preferably doped with aluminium (SiO₂:Al), with boron (SiO₂:B), with titanium (SiO₂:Ti) or with zirconium (SiO₂:Zr). However, the layers can alternatively also for example contain aluminium oxide (Al₂O₃).

In a particularly advantageous embodiment, the optical layer is the top layer of the layer stack. It is therefore the layer with the greatest distance from the substrate surface and is the final layer in the layer stack that is exposed and can be accessed and touched by people. Additional layers, especially with a higher refractive index than the anti-reflective layer, above the anti-reflective layer would change the optical properties and could reduce the desired effect.

It has been found that the oxygen content of the electrically conductive layer, particularly if it is based on a TCO, has a significant influence on the properties thereof, particularly transparency, coloration and conductivity. The production of the pane typically comprises a temperature treatment, such as a thermal prestressing process, wherein oxygen can diffuse to the conductive layer and oxidise it. The layer stack according to the invention comprises, between the electrically conductive layer and the optical layer, a dielectric blocking layer for controlling oxygen diffusion with a refractive index of at least 1.9 and a layer thickness of from 10 nm to 25 nm, preferably from 10 nm to 20 nm, particularly preferably from 12 nm to 20 nm, very particularly preferably from 12 nm to 18 nm, in particular from 15 nm to 18 nm. Particularly good results are obtained if the refractive index of the blocking layer is from 1.9 to 2.5. The blocking layer serves to adjust the oxygen supply to an optimum level. It has been found that at smaller layer thicknesses of the blocking layer, over-oxidation of the layer material can occur during temperature treatment. Over-oxidation can reduce the degree of electrical conductivity and emissivity-reducing effect of the layer stack. Within the aforementioned layer thickness ranges for the blocking layer, the conductivity and emissivity-reducing effect could be stabilised. This improvement was surprising and unexpected to the inventors.

The dielectric blocking layer for controlling oxygen diffusion contains at least a metal, a nitride or a carbide. For example, the blocking layer can contain titanium, chromium, nickel, zirconium, hafnium, niobium, tantalum or tungsten, or a nitride or carbide of tungsten, niobium, tantalum, zirconium, hafnium, chromium, titanium, silicon or aluminium. In a preferred embodiment, the blocking layer contains silicon nitride (Si₃N₄) or silicon carbide, in particular silicon nitride (Si₃N₄), with which particularly good results are achieved. The silicon nitride can have dopants and in a preferred development is doped with aluminium (Si₃N₄:Al), with zirconium (Si₃N₄:Zr), with titanium (Si₃N₄:Ti), or with boron (Si₃N₄:B). During temperature treatment after the application of the layer stack, the silicon nitride can be partially oxidised. A blocking layer deposited as Si₃N₄ then contains SiₓN_{y}O_{z} after temperature treatment, with the oxygen content typically ranging from 0 at. % to 35 at. %.

The layer stack contains, below the electrically conductive layer and below the anti-reflective layer, a dielectric barrier layer preventing alkali diffusion. The barrier layer reduces or prevents the diffusion of alkali ions from the glass substrate into the layer system. Alkali ions can negatively affect the properties of the coating. Furthermore, in combination with the anti-reflective layer, the barrier layer advantageously contributes to adjusting the coloration and reflection of the overall layer structure. The refractive index of the barrier layer is preferably at least 1.9. Particularly good results are obtained if the refractive index of the barrier layer is from 1.9 to 2.5. The barrier layer preferably contains an oxide, a nitride or a carbide, preferably of tungsten, chromium, niobium, tantalum, zirconium, hafnium, titanium, silicon or aluminium, for example oxides such as WO3, Nb₂O₅, Bi₂O₃, TiO₂, Ta₂O₅, ZrO₂, HfO₂SnO₂, or ZnSnOₓ, or nitrides such as AlN, TiN, TaN, ZrN or NbN. The barrier layer particularly preferably contains silicon nitride (Si₃N₄), which achieves particularly good results. The silicon nitride can have dopants and in a preferred development is doped with aluminium (Si₃N₄:Al), with titanium (Si₃N₄:Ti), with zirconium (Si₃N₄:Zr) or with boron (Si₃N₄:B). According to the invention, the thickness of the barrier layer is from 5 nm to 18 nm, particularly preferably from 10 nm to 18 nm, in particular from 12 nm to 18 nm. The barrier layer is preferably the lowest layer of the layer stack; i.e., it has direct contact with the substrate surface, where it can optimally develop its effect. Layer thicknesses of 5 nm to 18 nm, in particular 12 nm to 18 nm, are particularly suitable because they allow the pane to retain a good degree of deformability, for example during subsequent bending. At the same time, the barrier layer also serves as an adhesive layer for adhering the remaining layers to the substrate, which is why a layer thickness of more than 10 nm is preferred.

In an advantageous embodiment, the coating consists exclusively of layers with a refractive index of at least 1.9 or at most 1.8, preferably at most 1.6. In a particularly preferred embodiment, the layer stack consists only of the layers described and does not contain any further layers.

In a preferred embodiment of the invention, the barrier layer has a thickness of 5 nm to 18 nm, the anti-reflective layer has a thickness of 5 nm to 20 nm and the optical layer has a thickness of 55 nm to 75 nm. This achieves optimal optical properties in terms of reflection and coloration of the layer stack without compromising the stability or transparency of the pane. Particularly preferably, the layer stack consists only of the layers described, i.e. a blocking layer, anti-reflective layer, electrically conductive layer, barrier layer and optical layer, and contains no further layers.

In a very particularly preferred embodiment of the invention, the barrier layer has a thickness of 5 nm to 18 nm, the anti-reflective layer has a thickness of 5 nm to 20 nm and the optical layer has a thickness of 55 nm to 75 nm. At these layer thicknesses, only a very low degree of coloration and reflection is visually perceptible compared to in conventional panes.

The inventors have surprisingly discovered that a pane comprising the electrically conductive layer stack according to the invention, which is adjusted so as to have a local reflectance minimum in the range from 360 nm to 440 nm and a local reflectance maximum in the range from 310 nm to 360 nm at an angle of incidence of 8°, leads to a more neutral colour impression of the pane without the reflectance of the coated pane being significantly increased at the same time.

In a preferred embodiment of the invention, the reflectance of the surface of the substrate coated with the layer stack according to the invention is at most 10%, preferably at most 5%, in particular at most 4%, measured with visible light radiation incident on the coated surface of the substrate at an angle of incidence of 8°.

The local reflectance minimum is preferably in the range from 315 nm to 355 nm, particularly preferably from 320 nm to 350 nm. The local maximum reflectance is preferably in the range from 415 nm to 450 nm. The aforementioned local extreme values are to be understood as minimum requirements and are not intended to exclude the case that they are global extreme values. While in the case of the maximum reflectance there will exist spectral ranges with higher reflectance at least outside the visible range, it is conceivable that said local minimum reflectance is the global minimum in a mathematical sense.

The term “reflectance” is used in the sense of the standard DIN EN 410-2011-04. The reflectance always refers to the layer-side reflectance, which is measured when the coated surface of the pane faces the light source and the detector. Within the scope of the present invention, refractive indices are in all cases specified in relation to a wavelength of 550 nm. Methods for determining refractive indices are known to a person skilled in the art. The refractive indices specified within the scope of the invention can be determined, for example, by ellipsometry, wherein commercially available ellipsometers can be used. Unless otherwise indicated, the specification of layer thicknesses or thicknesses refers to the geometric thickness of a layer.

The reflectance is measured at an angle of incidence of 60° or 8° (unless otherwise stated) to the interior-side surface normal (surface of the substrate coated with the layer stack), which corresponds approximately to the natural viewing angle on the pane in a vehicle. The spectral range of 380 nm to 680 nm was used to characterise the reflection properties because the visual impression of an observer is primarily influenced by this spectral range.

The reflectance describes the proportion of the total irradiated radiation that is reflected. It is indicated in % (based upon 100%-emitted radiation) or as a unitless number from 0 to 1 (normalised to the emitted radiation). It forms the reflection spectrum when plotted as a function of the wavelength. The information on the reflectance or the reflection spectrum relates to a reflection measurement with a light source which radiates uniformly in the observed spectral range with a standardised radiation intensity of 100%.

The occurrence of local reflectance extremes is crucial for the reduced visibility of fingerprints or surface contamination. These properties can in principle be realised by a variety of designs of the layer structure of the coating, and the invention is not intended to be limited to a specific layer structure. In principle, the extreme value distribution is determined by the selection of the layer sequence, the materials of the individual layers and each of the layer thicknesses, wherein this distribution can be influenced by a temperature treatment process taking place after coating. However, certain embodiments have also proven to be particularly advantageous with regard to optimised material use and other optical properties presented below.

The interior-side emissivity of the pane according to the invention is preferably less than or equal to 45%, particularly preferably less than or equal to 35%, very particularly preferably less than or equal to 25%, in particular less than or equal to 20%. Here, interior-side emissivity is the measure that indicates how much heat radiation the pane emits into an interior, for example of a building or of a vehicle, in the installed position compared to an ideal heat emitter (a black body). In the sense of the invention, emissivity is understood to mean the normal emissivity at 283 K according to the standard EN 12898.

The surface resistance of the layer stack according to the invention is preferably from 10 ohms/square to 100 ohms/square, particularly preferably from ohms/square to 35 ohms/square.

The substrate is made of an electrically insulating, in particular rigid, material, preferably of glass or plastic. In a preferred embodiment, the substrate contains soda-lime glass, but can in principle also contain other types of glass, for example borosilicate glass or quartz glass. In a further preferred embodiment, the substrate contains polycarbonate (PC) or polymethyl methacrylate (PMMA). The substrate can be largely transparent or also tinted or coloured. The substrate preferably has a thickness of from 0.1 mm to 20 mm, typically from 2 mm to 5 mm. The substrate can be designed to be planar or curved. In a particularly advantageous embodiment, the substrate is a thermally tempered glass pane.

In a preferred embodiment of the invention, the pane has an a* value of the L*a*b* colour space of at most +10, preferably at most +5, in particular at most +3, at a viewing angle α of at least 60° on the coated surface. The layers of the layer stack are thus arranged in such a way that the a* value of the L*a*b* colour space is at most +10, preferably at most +5, in particular at most +3, at a viewing angle α of at least 60° on the coated surface. It has been found that a high a* content leads to a dominant coloration of the pane. The visually perceived coloration depends on the viewing angle α and is particularly pronounced for viewing angles above 60° in panes of the type in question.

The viewing angle α is measured on the basis of a normal with respect to the surface plane of the pane, i.e. an axis which is perpendicular to the surface plane of the pane. A viewing angle α of 0° accordingly means the vertical view onto one of the outer surfaces of the pane. A viewing angle α of 90° accordingly means the horizontal view along one of the outer surfaces of the pane.

The symbols a* and b* are values of the L*a*b* colour space, i.e. of a colour model that describes all perceptible colours. L* indicates the brightness value and can have values between 0 and 100. a* indicates the chromaticity and colour intensity between green and red, while b* indicates the chromaticity and colour intensity between blue and yellow. The more negative or positive the values of b* and a* are, the more intense the hue. For values close to 0 for a* and b*, the colour tone is rather achromatic, i.e. neutral.

Common measurement methods for determining a*, b* and L* values of the L*a*b* colour space (CIELAB) are generally known to a person skilled in the art. Common measuring instruments for determining this are commercially available, for example the Minolta CM508d spectrometer from Konica Minolta Sensing Europe B.V. or the Tec5 spectrometer from tec5 AG. In order to determine the a*, b* and L* values of the L*a*b* colour space, it is first necessary to define the measurement conditions. For example, the type of light (D50, D65, A or others; see DIN 5033-7:2014-10), the standard observer (2° or 10°; see DIN 5033-7:2014-10), the measurement geometry (directed or diffuse illumination; see DIN 5033-7:2014-10), the measurement mode (reflection in plan view or transmission in transmitted light), the measurement points of the sample and the number of measurements must be specified. The term “normal observer” is understood to mean the average sight of the population that sees standard colours at different visual field sizes (DIN 5033-7:2014-10). To enable a uniform evaluation, the International Commission on Illumination (CIE) defined spectral evaluation functions. The evaluation functions describe how a normal observer perceives colour. The evaluation is based on experimentally determined sensitivity curves of the long-wave, medium-wave and short-wave cones of the human eye (see also DIN 5033-1:2017-10).

For example, the coated pane can be illuminated at a predetermined angle to measure the a* value. However, illuminated at a “predetermined angle” does not necessarily mean that the light incident on the coated pane has an angle of incidence only of the predetermined angle. The coated pane can, for example, be illuminated with diffuse light, with the light impinging on the coated pane at a number of different angles of incidence, preferably at least at an angle of from 60° to 90°. A detector of a measuring device records the light reflected by the sample. The spectral intensity of the reflected light is obtained over a wavelength range of from 360 nm to 830 nm. The obtained spectrum is then integrated only in the regions that coincide with one of the sensitivity curves of the long-wave, medium-wave and short-wave cones. In this way, the integrals for the long-wave, medium-wave and short-wave light components are formed, which are then mathematically transformed into the a*, b* and L* values of the L*a*b* colour space according to DIN 6174:2007-10. It is self-evident that the detector measures the reflected light at the viewing angle α with respect to the pane to determine the a*, b* and L* values. A linear polarising filter can be arranged between the detector and the sample, i.e. in the beam path of the reflected light. The angle at which the sample is illuminated can be from 0° to 90°, preferably from 0° to 80°, to the surface of the coated pane (measured from a normal to the surface plane of the pane).

Preferably, an a* value of 10° is measured for the standard observer. Standard illuminant D65 (average daylight with approx. 6500 Kelvin) is preferably used. The measuring mode is preferably reflection in plan view and the coated pane is illuminated with diffuse light. The detector is preferably equipped with a linear polarising filter.

The substrate can be transparent or semi-transparent, for example tinted. Within the meaning of the invention, “transparent” means a light transmission (according to ISO 9050:2003) of at least 50%, preferably at least 60%, and particularly preferably at least 70%. Semitransparent (according to ISO 9050:2003) within the meaning of the invention means a light transmission of at most 50%, preferably at most 30% and particularly preferably at most 10%.

The invention further extends to a composite pane comprising
the coated pane according to the invention,
a second pane, and
a thermoplastic intermediate layer arranged between the coated pane and the second pane.

The second pane preferably comprises a substrate or substantially consists of a substrate. This is preferably constructed like the substrate of the coated pane.

The thermoplastic intermediate layer is preferably formed as at least one thermoplastic laminated film and is based on ethylene vinyl acetate (EVA), polyvinyl butyral (PVB), or polyurethane (PU) or mixtures or copolymers or derivatives thereof, particularly preferably based on polyvinyl butyral (PVB) and, in addition, additives known to a person skilled in the art, for example plasticisers. The thermoplastic film preferably contains at least one plasticiser.

The invention also comprises a method for producing a coated pane comprising an electrically conductive layer stack, wherein
(A) the substrate is provided, and
(B) the barrier layer, the anti-reflective layer, the electrically conductive layer, the blocking layer and the optical layer are applied to the surface in this order as a layer stack, preferably by means of magnetron sputtering.

After the application of the layer stack, the pane is preferably subjected to temperature treatment which in particular improves the crystallinity of the optical layer, in particular if the optical layer is a TCO layer. Temperature treatment takes place preferably at at least 300° C., particularly preferably at at least 500° C. Temperature treatment reduces in particular the sheet resistance of the coating. In addition, the optical properties of the pane or substrate are significantly improved, in particular the transmittance increases.

Temperature treatment can take place in various ways, for example by heating the pane or substrate by means of a furnace or a radiant heater. Alternatively, the temperature treatment can also take place by irradiation with light, for example with a lamp or a laser as a light source.

In an advantageous embodiment, in the case of a glass substrate, temperature treatment is carried out as part of a thermal tempering process. The heated substrate is exposed to an air stream, causing it to cool down quickly. Compressive stresses form on the pane surface and tensile stresses in the pane core. The characteristic stress distribution increases the breaking strength of glass panes. Tempering can also be preceded by a bending process.

The individual layers of the layer stack are deposited by per se known methods, preferably by magnetic field-assisted cathode sputtering (magnetron sputtering). This is particularly advantageous in terms of a simple, rapid, inexpensive, and uniform coating of the substrate. Sputtering takes place in an inert gas atmosphere, for example of argon, or in a reactive gas atmosphere, for example by adding oxygen or nitrogen. However, the layers may also be applied by other methods known to the person skilled in the art, for example by vapor deposition or chemical vapor deposition (CVD), by atomic layer deposition (ALD), by plasma-enhanced chemical vapor deposition (PECVD) or by wet chemical methods.

To select suitable materials and layer thicknesses to realise the suitable reflection spectrum, a person skilled in the art can, for example, make use of customary simulations.

The invention also comprises the use of a pane according to the invention in buildings, in electrical or electronic appliances or in modes of transport for traffic on land, in the air, or on water. The pane is preferably used as a window pane, for example as a window pane of a building or a roof window, side window, rear window or windshield of a vehicle, in particular of a motor vehicle.

In the following, the invention is explained in more detail with the aid of drawings and examples of embodiments. The drawings are schematic and are not to scale. The drawings do not limit the invention in any way.

In the drawings:

FIG. 1 is a cross section through an embodiment of the pane according to the invention comprising an electrically conductive layer stack,

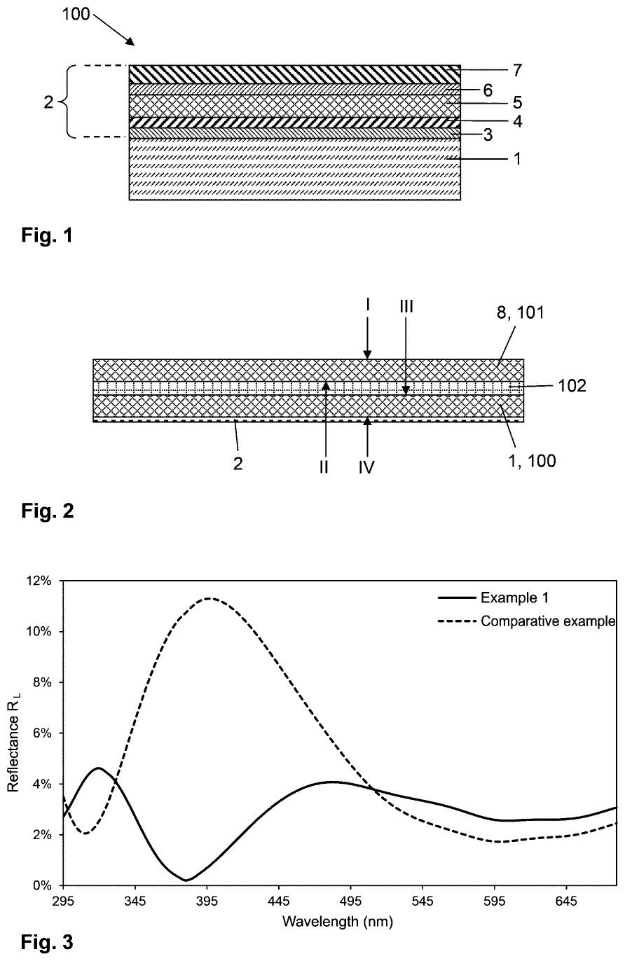

FIG. 2 is a cross section through an embodiment of a composite pane comprising the pane according to the invention,

FIG. 3-5 are diagrams of the reflectance R_{L} as a function of the wavelength for 4 examples according to the invention and one comparative example, and

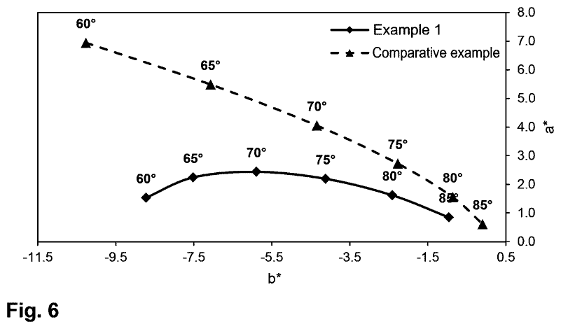

FIG. 6 is a diagram with a and b* as a function of on the viewing angle α for Example 1 and the comparative example.

FIG. 1 shows a cross section through an embodiment of the pane 100 according to the invention comprising the substrate 1 and the electrically conductive layer stack 2. The substrate 1 is, for example, a glass pane made of tinted soda-lime glass and has a thickness of 2.1 mm. The layer stack 2 is a heat radiation-reflecting coating (low-E coating). The pane 100 is provided as a roof window of a motor vehicle, for example. Roof windows are typically designed as laminated glass panes, wherein the substrate 1 is connected to an outer pane (not shown) via its surface facing away from the coating 2 by means of a thermoplastic film (see FIG. 2).

The optical properties of the layer stack 2 are optimised such that the layer stack reflects less visible light for a vehicle occupant without causing intense coloration of the pane 100 in comparison to conventional panes. According to the invention, this is achieved by a sequence of thin layers, which, starting from the substrate 1, consists of the following individual layers: a barrier layer 3 preventing alkali diffusion with a refractive index of at least 1.9, an anti-reflective layer 4 with a refractive index of at most 1.6, an electrically conductive layer 5, a blocking layer 6 for controlling oxygen diffusion with a refractive index of at least 1.9 and an optical layer 7 with a refractive index of at most 1.6.

An example embodiment of the layer sequence including materials and layer thicknesses is summarised in Table 1. The individual layers of the layer stack 2 were deposited by magnetic field-assisted cathode ray sputtering, for example. The low light reflection and the lower colour impression compared to conventional panes can be achieved in particular by the precisely adjusted layer thickness of the electrically conductive layer 5 and the blocking layer 6.

Table 1 with Example 1

| Layer | Reference signs | | Material | Thickness | |
|---|---|---|---|---|---|
| Optical layer | 7 | 2 | SiO₂ | 69 | nm |
| Blocking layer | 6 | | Si₃N₄ | 18 | nm |
| Electrically | 5 | | ITO | 95 | nm |
| conductive layer | | | | | |
| Anti-reflective layer | 4 | | SiO₂ | 10 | nm |
| Barrier layer | 3 | | Si₃N₄ | 15 | nm |

| | | | | |
|---|---|---|---|---|
| Substrate | 1 | Soda-lime glass | 2.1 | mm |

FIG. 2 is a cross-sectional view of a composite pane comprising the pane 100 according to the invention from FIG. 1 as the inner pane and a second pane 101 as the outer pane. The composite pane is, for example, a roof window that is installed in a vehicle. The electrically conductive layer stack 2 is applied to an interior-side surface IV of the substrate 1 that faces the vehicle interior. The substrate has an outer surface III that faces the thermoplastic intermediate layer 102 and also faces the external environment. The second substrate 8, which is also the second pane 101, has an interior-side surface II facing the vehicle interior and an outer surface I facing the external environment. The second pane 101 is, for example, 1.5 mm thick. The thermoplastic intermediate layer 102 consists, for example, of polyvinyl butyral with a plasticiser content of less than 10 percent by weight. The layer thickness of the thermoplastic intermediate layer is, for example, 0.5 mm.

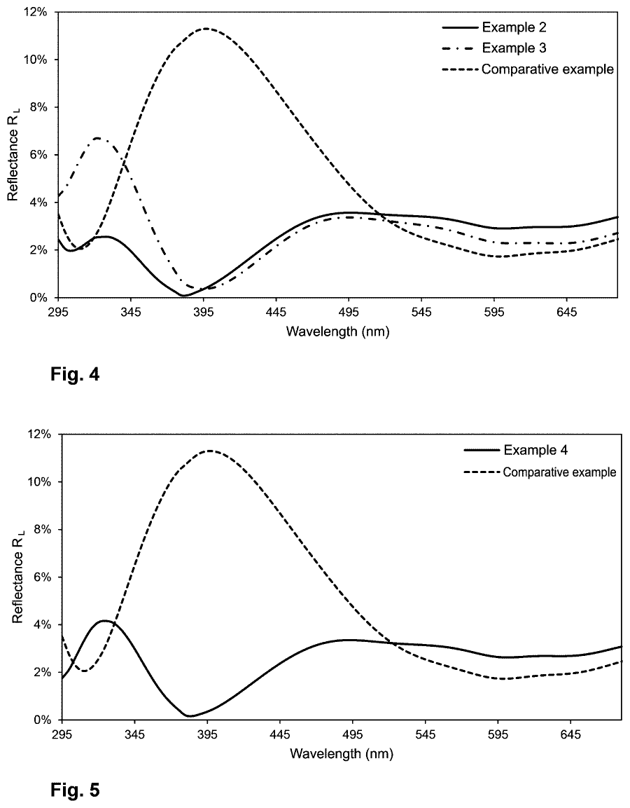

FIG. 3-5 show diagrams of the reflectance R_{L} for four examples according to the invention and one comparative example. The values of reflectance R_{L} shown were determined by simulations using the CODE software. FIG. 3 shows Example 1 and the comparative example. FIG. 4 shows Examples 2 and 3 and the comparative example. FIG. 5 shows Example 4 and the comparative example. The materials and layer thicknesses of the layer stack 2 of Example 1 are summarised in Table 1. The materials and layer thicknesses of the layer stack 2 of Examples 2 to 4 are summarised in Table 2, those of the comparative example in Table 3. In Examples 1-4, the pane consisted of a substrate 1 made of tinted soda-lime glass with a light transmission T_{L} of about 25% and the layer stack 2, which, proceeding from the substrate 1, was constructed from a barrier layer 3, an anti-reflective layer 4, an electrically conductive layer 5, a blocking layer 6 and an optical layer 7. The layers were made of the same materials, with the thickness of the layers of the layer stack 2 of Examples 1˜4 differing. All panes had undergone temperature treatment at approximately 650° C. as part of a glass bending process.

TABLE 2

| | | Thickness | | | | | |
|---|---|---|---|---|---|---|---|
| Layer | Material | Example 2 | | Example 3 | | Example 4 | |
| 7 | SiO₂ | 69 | nm | 75 | nm | 70 | nm |
| 6 | Si₃N₄ | 18 | nm | 18 | nm | 18 | nm |
| 5 | ITO | 95 | nm | 95 | nm | 85 | nm |
| 4 | SiO₂ | 15 | nm | 10 | nm | 15 | nm |
| 3 | Si₃N₄ | 15 | nm | 15 | nm | 18 | nm |
| 1 | Glass | 2.1 | mm | 2.1 | mm | 2.1 | mm |

TABLE 3

| | | Layer thickness | |
|---|---|---|---|
| Layer | Material | Comparative example | |
| 7 | SiO₂ | 45 | nm |
| 6 | Si₃N₄ | 9 | nm |
| 5 | ITO | 60 | nm |
| 4 | SiO₂ | 18 | nm |
| 3 | Si₃N₄ | 32 | nm |
| 1 | Glass | 2.1 | mm |

The comparative example shows a pane comprising a conventional layer stack. The comparative example differs fundamentally from Examples 1 to 4 according to the invention by the significantly smaller layer thickness of the electrically conductive layer 5, optical layer 7 and blocking layer 6. At the same time, the layer thickness of the anti-reflective layer 4 and the barrier layer 3 is significantly higher than for the examples according to the invention. The reflectance R_{L} in the range from 350 nm to 550 nm in the comparative example is, in most cases, significantly higher than for the examples according to the invention. Light reflections in this wavelength range in particular can be irritating for observers, such as the driver, which is why lower light reflection in this range is largely advantageous. The reflectance R_{L} shown in FIGS. 3 to 5 has been simulated for an angle of incidence of light on the layer stack 2 of 8°. The differences between the reflectance in the wavelength range between 350 nm and 550 nm of the examples according to the invention and the comparative example are also measurable for angles of incidence of 60°.

In contrast to Examples 1-4 according to the invention, the local extrema of the reflectance R_{L} in the comparative example were not between 310 and 360 nm (maximum) and 360 nm and 440 nm (minimum). The occurrence of local extrema is summarised in Table 4. The values of reflectance R_{L} shown were determined by simulations using the CODE software.

TABLE 4

| | Minimum R_{L} | Maximum R_{L} |
|---|---|---|
| Example 1 | 380 nm | 320 nm |
| Example 2 | 385 nm | 330 nm |
| Example 3 | 395 nm | 325 nm |
| Example 4 | 385 nm | 325 nm |
| Comparative example | 310 nm | 395 nm |

The lower reflection maxima in the higher wavelength range compared to conventional panes reduces optical irritation for viewers. Reflections in the lower wavelength range are generally perceived as more neutral coloured reflections.

FIG. 6 shows the a* and b* values (LAB colour space) for Example 1 and the comparative example. The a* and b* values shown are shown, depending on the viewing angle (60° to 85°), on the surface IV of the substrate 1 coated with the layer stack 2. It can be seen that the a* values, which are particularly responsible for a dominant coloration of the pane 100, are significantly lower in Example 1 according to the invention than in the comparative example. The b* values are, on average, similar for the comparative example and the inventive example 1 across the viewing angles. The pane 100 coated with the layer stack 2 according to the invention from Example 1 therefore provides an overall more colour-neutral impression than these types of coated pane.

### LIST OF REFERENCE SIGNS

1 Substrate
2 Layer stack
3 Barrier layer
4 Anti-reflective layer
5 Electrically conductive layer
6 Blocking layer
7 Optical layer
8 Second substrate
100 Pane
101 Second pane
102 Thermoplastic intermediate layer
I Outer surface of the second substrate 8
II Interior-side surface of the second substrate 8
III Outer surface of the substrate 1
IV Interior-side surface of the substrate 1
R_{L} Reflectance (according to DIN EN410)

1. A coated pane, comprising a substrate and an electrically conductive layer stack on a surface of the substrate, which, starting from the substrate, comprises at least
a dielectric barrier layer preventing ion diffusion with a refractive index of at least 1.9 and a layer thickness of 5 nm to 18 nm,
a dielectric anti-reflective layer with a refractive index of at most 1.6,
an electrically conductive layer with a layer thickness of 75 nm to 120 nm,
a dielectric blocking layer for controlling oxygen diffusion with a refractive index of at least 1.9 and a layer thickness of 10 nm to 25 nm, and
a dielectric optical layer with a refractive index of at most 1.6.

2. The pane according to claim 1, wherein the electrically conductive layer contains a transparent conductive oxide (TCO).

3. The pane according to either claim 1, wherein the electrically conductive layer has a thickness of 80 nm to 95 nm.

4. The pane according to claim 1, wherein the anti-reflective layer and/or the optical layer contains at least one oxide.

5. The pane according to claim 1, wherein the optical layer has a layer thickness of from 55 nm to 75 nm.

6. The pane according to claim 1, wherein the anti-reflective layer has a thickness of 5 nm to 20 nm.

7. The pane according to claim 1, wherein the barrier layer and/or the blocking layer contains a metal, a nitride or a carbide.

8. The pane according to claim 1, wherein the barrier layer has a thickness of from 12 nm to 18 nm.

9. The pane according to claim 1, wherein the blocking layer has a thickness of 12 nm to 25 nm.

10. The pane according to claim 1, which has a local reflectance minimum in the range of 360 nm to 440 nm and a local reflectance maximum in the range of 310 nm to 360 nm.

11. The pane according to claim 1, which has an emissivity over the coated surface of at most 25% compared to an ideal heat emitter.

12. The pane according to claim 1, wherein, at a viewing angle a of at least 60° onto the coated surface, the pane has an a* value of the L*a*b* colour space of at most +10.

13. A laminated pane, comprising
a coated pane according to claim 1,
a second pane and
a thermoplastic intermediate layer arranged between the coated pane and the second pane.

14. A method for producing a coated pane according to claim 1, the method comprising:
(A) providing the substrate, and
(B) applying the barrier layer, the anti-reflective layer, the electrically conductive layer, the blocking layer and the optical layer to the surface in this order as a layer stack.

15. A method comprising providing a coated pane according to claim 1 in a building, in an electrical or electronic appliance or in a transport vehicle for traffic on land, in the air or on water.

16. The pane according to claim 2, wherein the electrically conductive layer contains indium tin oxide (ITO).

17. The pane according to claim 4, wherein at least one oxide is silicon oxide, or aluminium-doped, zirconium-doped, titanium-doped or boron-doped silicon oxide.

18. The pane according to claim 5, wherein the optical layer has a layer thickness of from 60 nm to 70 nm.

19. The pane according to claim 6, wherein the anti-reflective layer has a thickness of 10 nm to 15 nm.

20. The pane according to claim 7 wherein the barrier layer and/or the blocking layer contains a silicon nitride or silicon carbide.
